(19) United States
(12) Patent Application Publication
(10) Pub. No.: US 2019/0104692 A1
(43) Pub. Date: Apr. 11, 2019

(54) Moisture Sealing Flexible Plant Enclosure

(71) Applicant: Lucinni Bailar, Houston, TX (US)

(72) Inventor: Lucinni Bailar, Houston, TX (US)

(21) Appl. No.: 15/727,411

(22) Filed: Oct. 6, 2017

(51) Int. Cl. A01G 13/04; A01G 27/02

(52) U.S. Cl. CPC A01G 13/043; A01G 13/0237; A01G 27/02

(57) ABSTRACT

A moisture sealing flexible plant enclosure encloses a potted plant and maintains ideal moisture levels for the potted plant to thrive. The moisture sealing flexible plant enclosure includes a flexible plant enclosure, an irrigation system, and a sealing mechanism. The flexible plant enclosure fits over a plant contained in a drainable pot and facilitates a humid environment which helps the plant remain hydrated. The irrigation system allows water to enter the flexible plant enclosure while preventing significant amount of moisture from escaping. The sealing mechanism selectively closes the opening of the flexible plant enclosure thereby creating an airtight seal. This creates a high humidity environment inside the flexible plant enclosure which keeps the plant hydrated.

### FIELD OF THE INVENTION

The present invention generally relates to a moisture sealing plant bag. More specifically, a moisture sealing plant bag includes an irrigation system for hydrating a plant and a flexible plant enclosure, wherein the flexible plant enclosure is dimensioned to retain a supply of water that passively hydrates the plant.

### BACKGROUND OF THE INVENTION

The present invention is a moisture preserving plant bag for keeping plants hydrated over prolonged periods of times. Plants must be watered frequently to prevent them from drying out. Conventional watering methods rely on watering the plant placed inside an open-top pot.

Oftentimes these open-top pots have drainage holes for draining excessive water that accumulates at the bottom portion of the pot. The drain at the bottom of the pot is allows water in the soil to drain which helps aerate the roots in the soil. Plant roots need oxygen to gather water and nutrients for the plant. Thus, the water must be directed away from the roots once the roots are sufficiently hydrated.

However, the drain may cause water to exit out of the pot before sufficiently hydrating the plant. This coupled with the moisture escaping from the topsoil quickly evaporates any moisture from the pot.

The present invention prevents the loss of moisture from the topsoil and retains the drained water in a spillover area. The plant is contained in a flexible plant enclosure capable of adjustably fitting pots of various sizes. An opening allows the stems of the plant to be exposed from the plant enclosure. A sealing mechanism mounted to the opening creates an airtight seal which prevents moisture from evaporating out of the flexible plant enclosure.

An irrigation system allows water to enter the flexible plant enclosure while preventing moisture from escaping therethrough. The flexible plant enclosure is constructed with a flat base portion that is substantially larger in area than the floor of the drainable pot. Water drains out of the pot and flows into the spillover area. When the roots of the plants get dry, the plants can access the water in the spillover area. More specifically, the dry soil naturally absorbs moisture through capillary action. Thus, the plant is simultaneously hydrated and aerated.

### BRIEF DESCRIPTION OF THE DRAWINGS

FIG. 1 is a top perspective view of the present invention.

FIG. 2 shows a top perspective view of the flexible plant enclosure with the drainable pot positioned illustrated in broken lines.

FIG. 3 shows a bottom perspective view of the flexible plant enclosure with the drainable pot illustrated in broken line.

FIG. 4 is a top perspective view of the drainable pot.

FIG. 5 is a detailed view of section D in FIG. 2, wherein the present invention is illustrated with the irrigation system, the string, and the string conduit.

FIG. 6 is a detailed view of section D in FIG. 2, wherein the present invention is illustrated with the irrigation system, the drawstring, and the plurality of string loops.

### DETAILED DESCRIPTION OF THE INVENTION

All illustrations of the drawings are for the purpose of describing selected versions of the present invention and are not intended to limit the scope of the present invention.

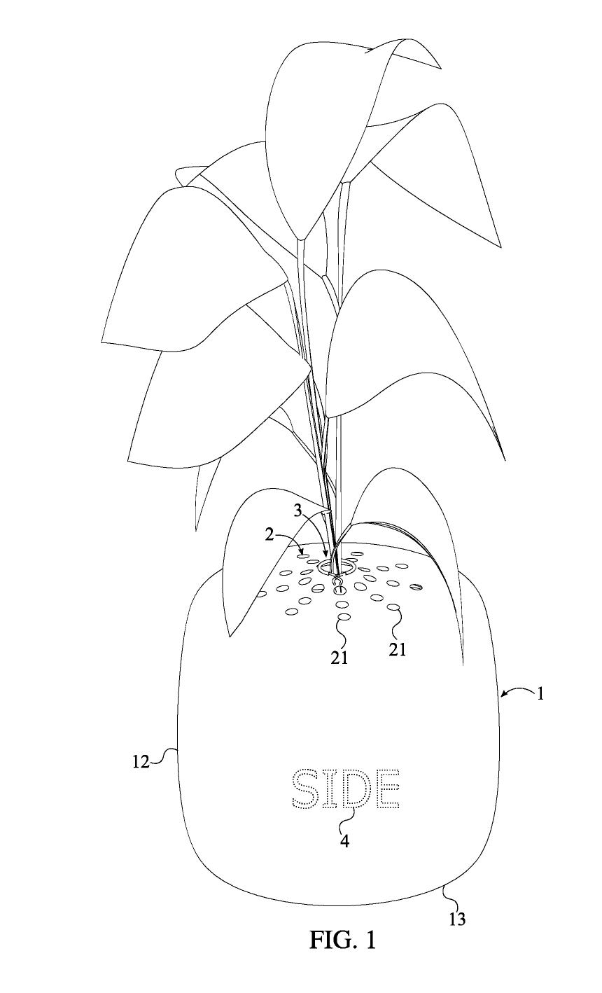

In reference to FIG. 1, the present invention is moisture sealing plant bag that prevents a floral plant contained in a pot from losing moisture. The preferred embodiment of the present invention comprises a flexible plant enclosure 1, an irrigation system 2, and a sealing mechanism 3. The flexible plant enclosure 1 fits over a drainable pot 6 or a durable container containing potting soil for growing plants, herbs, and vegetables. In the preferred embodiment, the flexible plant enclosure 1 is configured to accommodate drainable pots containing thin stemmed floral plants, however, any type of plant can be accommodated in alternate embodiments. The preferred flexible plant enclosure 1 is made of flexible polymeric materials that prevents water and air from permeating out of the lateral and the base section. In alternate embodiment, the general shape and size of the flexible plant changes according to the varying dimensions of the drainable plant.

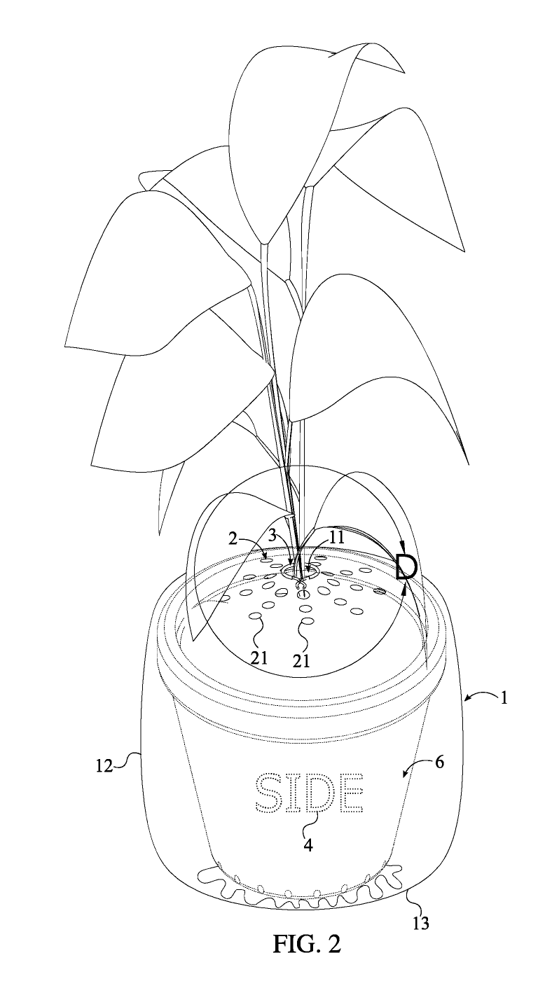

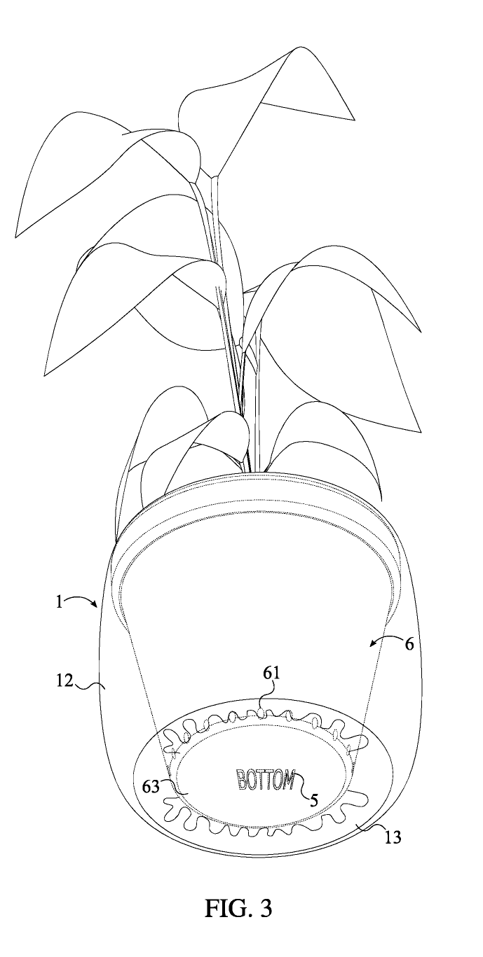

The flexible plant enclosure 1 comprises an opening 11, a lateral portion 12, and a base portion 13. FIG. 2 shows the opening 11 perimetrically delineated by the lateral portion 12, opposite the base portion 13. The drainable pot 6 is inserted into the flexible plant enclosure 1 through the opening 11. The opening 11 can be selectively closed to seal the interior of the flexible plant enclosure 1. In the closed position, only the stems and the flowers are exposed outside the flexible plant enclosure 1. FIG. 3 shows the lateral portion 12 perimetrically connected around the base portion 13. In the preferred embodiment of the present invention, a vertically standing drainable pot 6 rests on top of the base portion 13. As such, the lateral portion 12 is configured to remain generally perpendicular to the base portion 13. This permits the lateral portion 12 to easily cover the top of the drainable pot 6. The irrigation system 2 is integrated into the lateral portion 12, adjacent to the opening 11. The irrigation system 2 irrigates the topsoil of the potting soil, while preventing excessive moisture from leaking out of the flexible enclosure. Water enters through the irrigation system 2 and falls on the topsoil, thereby hydrating the potting soil and the floral plant. The sealing mechanism 3 is operatively integrated into the opening 11, wherein the sealing mechanism 3 is used to hermetically seal the opening 11. More specifically, the sealing mechanism 3 causes opening 11 to selectively constrict around the stems of the floral plants, thereby sealing off the interior of the flexible plant enclosure 1. The irrigation system 2 still allows air to permeate in and out of the flexible plant enclosure 1, but the loss of moisture is negligible.

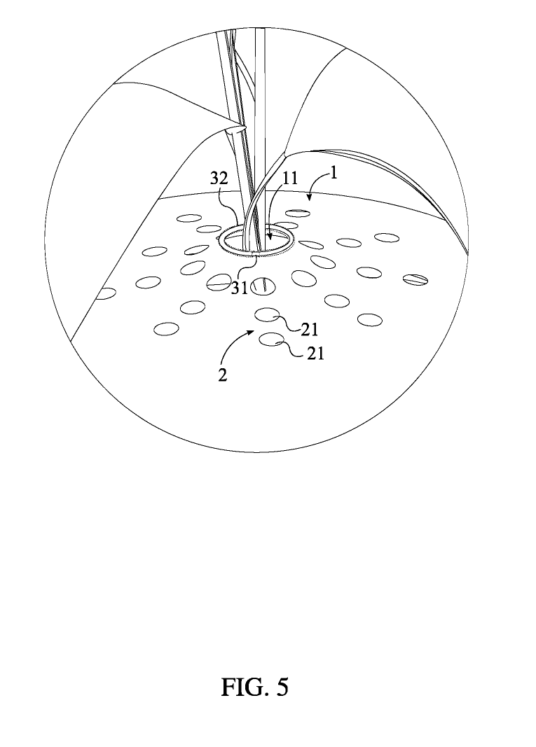

Referring now to FIG. 5, the sealing mechanism 3 comprises a string 31 and a string conduit 32. The string 31 is a stretchable string with an adjustable circumference. Likewise, the string conduit 32 includes a stretchable circular tube integrated into the flexible plant enclosure 1. In the preferred embodiment, the string conduit 32 is externally connected to the lateral portion 12 and the string conduit 32 is positioned around the opening 11. The string 31 traverses through the string conduit 32. More specifically, an operative connection is formed by inserting the string 31 into the circular tube of the string conduit 32. The stretchable circular tube allows the string 31 to expand to the maximum dimensions while remaining inside the string conduit 32. As such, the user can increase the effective size of opening 11 by physically stretching the string 31. For example, the user may stretch the string 31 wide to install the drainable pot 6 through the opening 11. Once the drainable pot 6 is inside the flexible plant enclosure 1, the string 31 contracts around the stems of the floral plants, thereby sealing the opening 11.

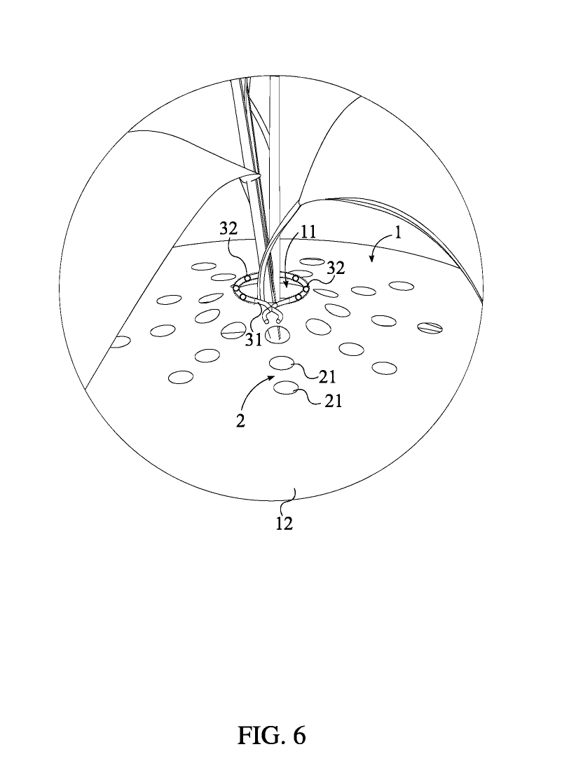

In an alternate embodiment of the present invention, the sealing mechanism 3 comprises a drawstring 33 and a plurality of string loops 34. Referring now to FIG. 6, the drawstring 33 and the plurality of string loops 34 allow the user to selectively close the opening 11. In this embodiment, the plurality of string loops 34 is externally connected around the lateral portion 12. Moreover, the plurality of string loops 34 is distributed around the opening 11. The plurality of string loops 34 helps position the drawstring 33 to around the opening 11. The internal channel can be collapsed by bringing each of the plurality of string loops 34 closer to each other. The drawstring 33 traverses through each of the plurality of string loops 34. More specifically, drawstring 33 inserts into the internal channel, traveling through each of the plurality of string loops 34 in the process. This operatively connects the drawstring 33 to the flexible plant enclosure 1. In the preferred embodiment of the present invention, the plurality of string loops 34 may be eyelets. The drawstring 33 travel through each of the plurality of strip loops 34. In order to close the opening 11, the user pulls the ends of the drawstring 33 out of the internal channel. This forces the plurality of string loops 34 to come closer together, which causes the opening 11 to constrict around the stems of the floral plants.

Referring once again to FIG. 5, the irrigation system 2 comprises a plurality of holes 21. The plurality of holes 21 allows water to permeate into the flexible enclosure. The plurality of holes 21 traverses through the lateral portion 12. Further, the plurality of holes 21 is radially distributed around the lateral portion 12. More specifically, the plurality of holes 21 is positioned on an area of the lateral portion 12 that covers the top of the drainable pot 6. The plurality of holes 21 is also positioned offset from the opening 11. This ensures that the plurality of holes 21 is positioned directly over the drainable pot 6, which allows water to fall directly on top of the topsoil. In the preferred implementation, the user waters the plant by sprinkling water over the plurality of holes 21. As such, the plurality of holes 21 is sized to allow most of the water to enter into the flexible plant enclosure 1 while preventing large amount of moisture from the escaping out of the flexible plant enclosure 1.

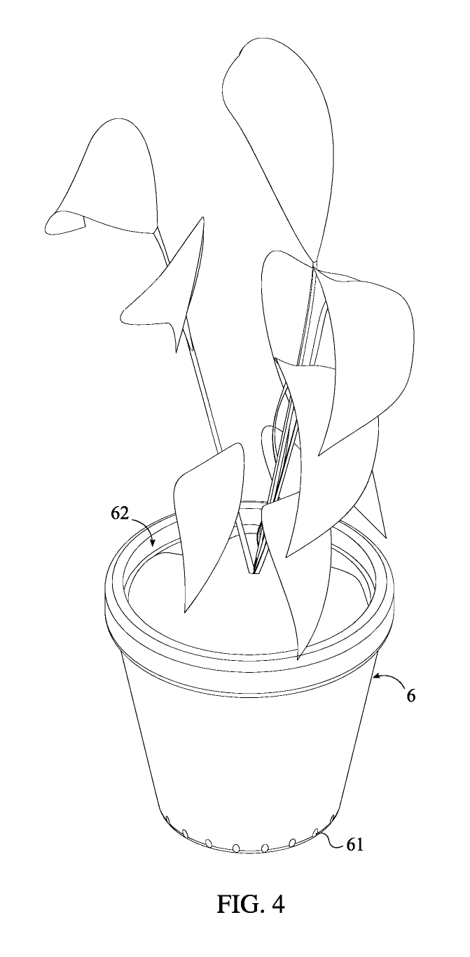

A system for utilizing the present invention also comprises a drainable pot 6. Referring again to FIG. 4, the drainable pot 6 comprises a plurality of drains 61, an interior recess 62, and an integrated floor 63. The plurality of drains 61 allows moisture accumulated in the potting soil to be drained out of the drainable pot 6. Floral plants and the accompanying potting soils is secured inside the interior recess 62. The integrated floor 63 secures the bottom opening 11 of the drainable pot 6.

FIG. 2 and FIG. 3 shows the drainable pot 6 positioned inside the flexible plant enclosure 1, wherein the opening 11 and the irrigation system 2 of the flexible plant enclosure 1 are positioned opposite the interior recess 62. As such, the plurality of holes 21 is positioned directly over the topsoil. The water falls on top of the topsoil and starts permeating through the potting soil. The integrated floor 63 is positioned coincident to the base portion 13, wherein the area of the base portion 13 is bigger than the area of the integrated floor 63. Once the water has permeated through the topsoil, the water eventually accumulates on top of the integrated floor 63. For this reason, the plurality of drains 61 is positioned adjacent to the integrated floor 63. Further, the plurality of drains 61 is integrated into the bottom portion of the drainable pot 6, whereby gravity causes the water to drain out of the drainable pot 6. The base portion 13 acts as a spillover area that retains excessive amounts of water that drains out of the drainable pot 6. Excessive water supply is drained out of the plurality of holes 21 and stored in the spillover area. As such, excessive water stored in the spillover area acts as an emergency reservoir that easily accessible to the floral plant. For example, if the user fails to water the floral plant for prolonged periods of time, the floral plant can access the water stored in the spillover area to prevent itself from getting excessively dry. In addition, dry potting soil exploits capillary action exhibited by the water, to passive absorb the water from the spillover area. Even a small amount of water that comes into contact with the dry potting soil can trigger the capillary action, and successfully rehydrate the floral plant.

In the preferred embodiment of the present invention, the lateral portion 12 and the base portion 13 are made of a transparent material. This allows the user to inspect the spillover area and determine if the water needs to be rehydrated. In alternate embodiments, the lateral portion 12 and the base portion 13 are made of a translucent material. The translucent material enables a semitransparent construction that may enable the user to partially inspect the interior of the flexible plant enclosure 1.

In addition, a first visual-indicating fixture 4 informs the user of relevant information. FIG. 2 shows the first visual-indicating fixture 4 externally mounted onto the lateral portion 12. Likewise, a second visual-indication fixture provides the user with another way of informing the user of relevant information. FIG. 3 shows the second visual-indicating fixture 5 is externally mounted onto the base portion 13.

Although the invention has been explained in relation to its preferred embodiment, it is to be understood that many other possible modifications and variations can be made without departing from the spirit and scope of the invention as hereinafter claimed.

What is claimed is:

1. A moisture sealing plant bag comprises:
a flexible plant enclosure;
an irrigation system;
a sealing mechanism;
the flexible plant enclosure comprises an opening, a lateral portion, and a base portion;
the lateral portion being perimetrically connected around the base portion;
the opening being perimetrically delineated by the lateral portion, opposite the base portion;
the irrigation system being integrated into the lateral portion, adjacent to the opening; and
the sealing mechanism being operatively integrated into the opening, wherein the sealing mechanism is used to hermetically seal the opening.

2. The moisture sealing plant bag as claimed in claim 1 comprises:
the sealing mechanism comprises a string and a string conduit;
the string conduit being externally connected the lateral portion;
the string conduit being positioned around the opening; and
the string traversing through the string conduit.

3. The moisture sealing plant bag as claimed in claim 1 comprises:
the sealing mechanism comprises a drawstring and a plurality of string loops;
the plurality of string loops being externally connected around the lateral portion;
the plurality of string loops being distributed around the opening; and
the drawstring traversing through each of the plurality of string loops.

4. The moisture sealing plant bag as claimed in claim 1 comprises:
the irrigation system comprises a plurality of holes;
the plurality of holes traversing through the lateral portion;
the plurality of holes being radially distributed around the lateral portion; and
the plurality of holes being positioned offset from the opening.

5. The moisture sealing plant bag as claimed in claim 1, wherein the lateral portion and the base portion are made of a transparent material.

6. The moisture sealing plant bag as claimed in claim 1, wherein the lateral portion and the base portion are made of a translucent material.

7. The moisture sealing plant bag as claimed in claim 1 comprises:
a first visual-indicating fixture; and
the first visual-indicating fixture being externally mounted onto the lateral portion.

8. The moisture sealing plant bag as claimed in claim 1 comprises:
a second visual-indicating fixture; and
the second visual-indicating fixture being externally mounted onto the base portion.

9. A system for utilizing the moisture sealing plant bag as claimed in claim 1 comprises:
the drainable pot comprises a plurality of drains, an interior recess, and an integrated floor;
the drainable pot being positioned inside the flexible plant enclosure, wherein the opening and the irrigation system of the flexible plant enclosure are positioned opposite the interior recess;
the integrated floor being positioned coincident to the base portion, wherein the area of the base portion is bigger than the area of the integrated floor; and
the plurality of drains being positioned adjacent to the integrated floor.

10. A moisture sealing plant bag comprises:
a flexible plant enclosure;
an irrigation system;
a sealing mechanism;
the sealing mechanism comprises a string and a string conduit;
the flexible plant enclosure comprises an opening, a lateral portion, and a base portion;
the lateral portion being perimetrically connected around the base portion;
the opening being perimetrically delineated by the lateral portion, opposite the base portion;
the irrigation system being integrated into the lateral portion, adjacent to the opening;
the sealing mechanism being operatively integrated into the opening, wherein the sealing mechanism is used to hermetically seal the opening;
the string conduit being externally connected the lateral portion;
the string conduit being positioned around the opening; and
the string traversing through the string conduit.

11. The moisture sealing plant bag as claimed in claim 10 comprises:
the irrigation system comprises a plurality of holes;
the drainable pot comprises a plurality of drains, an interior recess, and an integrated floor;
the plurality of holes traversing through the lateral portion;
the plurality of holes being radially distributed around the lateral portion;
the plurality of holes being positioned offset from the opening;
the drainable pot being positioned inside the flexible plant enclosure, wherein the opening and the irrigation system of the flexible plant enclosure are positioned opposite the interior recess;
the integrated floor being positioned coincident to the base portion, wherein the area of the base portion is bigger than the area of the integrated floor; and
the plurality of drains being positioned adjacent to the integrated floor.

12. The moisture sealing plant bag as claimed in claim 10, wherein the lateral portion and the base portion are made of a transparent material.

13. The moisture sealing plant bag as claimed in claim 10 comprises:
a first visual-indicating fixture;
a second visual-indicating fixture;
the first visual-indicating fixture being externally mounted onto the lateral portion; and
the second visual-indicating fixture being externally mounted onto the base portion.

14. A moisture sealing plant bag comprises:
a flexible plant enclosure;
an irrigation system;
a sealing mechanism;
the sealing mechanism comprises a drawstring and a plurality of string loops;
the flexible plant enclosure comprises an opening, a lateral portion, and a base portion;
the lateral portion being perimetrically connected around the base portion;
the opening being perimetrically delineated by the lateral portion, opposite the base portion;
the irrigation system being integrated into the lateral portion, adjacent to the opening; and
the sealing mechanism being operatively integrated into the opening, wherein the sealing mechanism is used to hermetically seal the opening;
the plurality of string loops being externally connected around the lateral portion;
the plurality of string loops being distributed around the opening; and
the drawstring traversing through each of the plurality of string loops.

15. The moisture sealing plant bag as claimed in claim 14 comprises:
the irrigation system comprises a plurality of holes;
the drainable pot comprises a plurality of drains, an interior recess, and an integrated floor;
the plurality of holes traversing through the lateral portion;
the plurality of holes being radially distributed around the lateral portion;
the plurality of holes being positioned offset from the opening;
the drainable pot being positioned inside the flexible plant enclosure, wherein the opening and the irrigation system of the flexible plant enclosure are positioned opposite the interior recess;
the integrated floor being positioned coincident to the base portion, wherein the area of the base portion is bigger than the area of the integrated floor; and
the plurality of drains being positioned adjacent to the integrated floor.

16. The moisture sealing plant bag as claimed in claim 14, wherein the lateral portion and the base portion are made of a translucent material.

17. The moisture sealing plant bag as claimed in claim 14 comprises:
a first visual-indicating fixture;
a second visual-indicating fixture;
the first visual-indicating fixture being externally mounted onto the lateral portion; and
the second visual-indicating fixture being externally mounted onto the base portion.
